(19) United States
(12) Patent Application Publication
(10) Pub. No.: US 2011/0070482 A1
(43) Pub. Date: Mar. 24, 2011

(54) GALVANIC ELEMENT HAVING FOIL SEAL

(75) Inventors: Thomas Woehrle, Stuttgart (DE); Claudia Kragler, Unterschneidheim (DE); Roland Frantz, Westhausen (DE); Juergen Roehberg, Ellwangen (DE); Johannes Maier, Ellwangen (DE); Heinrich Stelzig, Rosenberg (DE)

(73) Assignee: VARTA MICROBATTERY GMBH, Hannover (DE)

(21) Appl. No.: 12/933,514

(22) PCT Filed: Mar. 19, 2009
(86) PCT No.: PCT/EP09/02020

§ 371 Date: Dec. 1, 2010

(30) Foreign Application Priority Data
Mar. 20, 2008 (DE) 10 2008 015 965.4

(51) Int. Cl. H01M 2/02; B32B 27/00

(52) U.S. Cl. 429/176; 428/220

(57) ABSTRACT

A galvanic element with a metallic foil housing which encloses at least one positive and at least one negative electrode, wherein the foil housing is sealed by a plastics foil including at least partly of a polymer which has acid groups and/or which has anhydride groups, and/or which has groups derived therefrom.

### RELATED APPLICATIONS

This is a §371 of International Application No. PCT/EP2009/002020, with an international filing date of Mar. 19, 2009 (WO 2009/115324 A1, published Sep. 24, 2009), which is based on German Patent Application No. 10 2008 015 965.4, filed Mar. 20, 2008, the subject matter of which is incorporated by reference.

### TECHNICAL FIELD

This disclosure relates to a galvanic element with a metallic foil housing which encloses at least one positive and at least one negative electrode, to an electronic chip card which has this type of galvanic element, and also to a multilayer composite foil and use thereof as sealing material for sealing the housing of galvanic elements.

### BACKGROUND

Lithium-ion cells, in particular lithium-polymer cells (primary and secondary) can be produced in the form of very thin, flexible flat cells, and thus have very good suitability as energy-storage systems for chip cards, in particular for electronic chip cards, e.g., those known as “Active Smart Cards.” In electronic chip cards of this type, energy-storage systems are needed to supply power to an IC chip or to other modules, for example, integrated miniature sensors or transponders.

Electronic chip cards are composed of the actual body of the card, various electronic modules, e.g., the abovementioned IC chip, and the energy-storage system. The entire card must have ISO-conformity to DIN ISO 7816-1 and DIN-ISO/IEC 10 373. Lithium-ion cells or lithium-polymer cells suitable as energy-storage systems for electronic chip cards generally have a metallic housing which encloses the electrodes and provides protection from environmental effects and moisture. This type of housing is generally based on two housing halves bonded to one another by a sealable layer. The sealable layer insulates the two housing halves from one another and also has a sealing function. Ethylene-vinyl acetate (EVA) has, by way of example, very good suitability as sealable material. By way of example, EVA has relatively high heat resistance and good aging resistance. However, the adhesion properties of EVA are not always satisfactory and, particularly in the case of foil housings made of copper, these have in the past often caused problems.

It could therefore be helpful to provide a foil material which is an alternative to EVA and which, like EVA, has high heat resistance and good aging resistance, but which has improved properties in respect of its adhesion to metals, in particular to copper. It could also be helpful that the novel sealing material provides galvanic elements with improved quality of seal, these also being particularly suitable for use in electronic chip cards.

### SUMMARY

We provide a galvanic element with a metallic foil housing which encloses at least one positive and at least one negative electrode, wherein the foil housing is sealed by a plastics foil including at least partly a polymer which has acid groups and/or which has anhydride groups, and/or which has groups derived therefrom.

We also provide a multilayered composite foil including at least two layers made of a polymer having acid groups and/or having anhydride groups, and/or having groups derived therefrom, at least one layer made of a polyolefin arranged between the at least two layers made of the polymer having acid groups and/or having anhydride groups, and/or having groups derived therefrom, and at least one further layer made of a further polymer arranged between the at least onelayer made of the polyolefin and the at least two layers made of the polymer having acid groups and/or having anhydride groups, and/or having groups derived therefrom.

### BRIEF DESCRIPTION OF THE DRAWINGS

FIG. 1 is a schematic plan view of a housing half.

FIG. 2 is a graph of time in days versus amount of water measured.

FIG. 3 is a graph of time in hours versus voltage.

### DETAILED DESCRIPTION

Our galvanic element has a preferably multipart, metallic foil housing which encloses at least one positive and at least one negative electrode. It is preferable that the galvanic element comprises precisely one positive and precisely one negative electrode. A feature of the foil housing is that it has been sealed by a plastics foil which is composed at least to some extent of a polymer which has acid groups and/or which has anhydride groups, and/or which has groups derived therefrom.

The plastics foil insulates the parts of the foil housing from one another. It functions simultaneously as an electrical insulator and as a means of sealing which suppresses penetration of moisture into the interior of the foil housing and, respectively, into the interior of the cell. It forms a sealable layer. The metallic foil housing preferably functions not only as a simple housing, but also as an electrical current collector.

The foil housing may be composed of two halves, one of which is in preferably direct contact with the at least one positive electrode and the other is in preferably direct contact with the at least one negative electrode. The halves then form the poles of the galvanic element, at which the current can be taken. It is preferable that the plastics foil has been arranged in the form of peripheral strip between the two halves.

Surprisingly, it has been found that plastics foils having a proportion of a polymer having acid groups and/or having anhydride groups, and/or having groups derived therefrom have excellent properties of adhesion to metals and in particular to copper, and at the same time are also resistant to the electrochemical stresses that occur in a galvanic element. Another factor which could not a priori be excluded was that the reactive acid groups and/or anhydride groups, and/or groups derived therefrom, in the plastics foil could have a disruptive effect on the electro-chemical processes, but this was not observed. The foils form a remarkably good barrier to ingress of moisture.

The plastics foil is preferably a multilayer composite foil, where at least one layer of the composite foil is composed of the polymer having acid groups and/or having anhydride groups, and/or having groups derived therefrom.

The polymer having acid groups and/or having anhydride groups, and/or having groups derived therefrom is, in particular, an acrylic- and/or methacrylic-acid-based polymer. Polymers which have proven particularly suitable are those obtained via copolymerization of a nonpolar monomer with a polar monomer. Examples that may be mentioned of these are ethylene-methacrylic acid copolymers (abbreviated to EMAA, e.g., Surlyn® from DuPont) and ethylene-acrylic acid copolymers (abbreviated to EAA). The proportion of polar monomers in the polymers is preferably from 1% to 15%, preferably from 5% and 10%.

Particular groups derived from the acid groups and/or from the anhydride groups are ionic or salt-type groups deriving from the groups, in particular carboxylate groups.

The composite foil may have at least one layer made of a preferably unmodified, in particular, pure and nonpolar polyolefin. This is preferably polypropylene (PP).

It is particularly preferable that the composite foil has at least two, with preference precisely two, layers made of the polymer having acid groups and/or having anhydride groups, and/or having groups derived therefrom, and has at least one, preferably precisely one, layer made of the polyolefin, where the latter layer has preferably been arranged between the at least two, or precisely two, layers made of the polymer having acid groups and/or having anhydride groups, and/or having groups derived therefrom.

Particular preference is therefore given, as composite foil, to a foil with an EAA-polyolefin-EAA sequence or EMAA-polyolefin-EMAA sequence, where the polyolefin is preferably polypropylene.

It can moreover be preferable that, between the layer made of the polyolefin and the layers made of the polymer having acid groups and/or having anhydride groups, and/or having groups derived therefrom, at least one further layer made of a further polymer has been arranged, where this further layer can in particular serve as an adhesion promoter or as an adhesion-promoting layer.

The further polymer can, in particular, be a polyolefin, in particular a polyethylene, particularly preferably LDPE (low-density polyethylene).

Particular preference is therefore also given to composite foils with a sequence using five layers, namely in particular:
EAA
adhesion-promoting layer (made of the further polymer)
polyolefin
adhesion-promoting layer (made of the further polymer)
EAA
   or
EMAA
adhesion-promoting layer (made of the further polymer)
polyolefin
adhesion-promoting layer (made of the further polymer)
EMAA.

A galvanic element preferably has, as at least one positive electrode, at least one lithium intercalation electrode. Preference is given to positive electrodes based on MnO₂ (manganese dioxide). These generally comprise a polymer binder, for example, a polyvinylidene fluoride-hexafluoropropylene copolymer (e.g., Kynar®Flex 2801 from Arkema). The electrolyte used generally comprises a solution of a lithium salt (e.g., LiClO₄) in familiar organic carbonates, for example. in propylene carbonate.

As mentioned above, the at least one positive electrode may have connection directly to the housing. The connection to the housing is preferably produced as described in DE 10 2004 038 072. By way of example, therefore, a composite made of positive electrode and separator can be produced via lamination, and secure connection to the housing can be obtained as in the instructions given in DE 10 2004 038 072, by way of an electrically conductive means of connection. It is preferable to produce a composite made of positive electrode and separator as described in DE 101 25 619. The content of DE 10 2004 038 072 and DE 101 25 619 is hereby incorporated by reference into the content of this description.

A galvanic element preferably has, as at least one negative electrode, metallic lithium. The galvanic element may therefore be a primary lithium cell. The lithium is preferably applied under pressure to one of the housing parts or to one of the halves, and then takes the form of a thin layer.

The foil housing of a galvanic element may be composed of copper and/or of a copper alloy. Copper-magnesium alloys are particularly suitable as copper alloy. As mentioned above, the plastics foils exhibit particularly good adhesion in particular to housing materials of this type.

The galvanic element may take the form of a flat cell. The cell height thereof is preferably not more than 500 μm. The cell capacity thereof is very generally not more than 50 mAh.

This disclosure encompasses not only the galvanic element, but also the use of a multilayer composite foil as a sealing material, and also this multilayer composite foil itself.

A multilayer composite foil encompasses at least two, preferably precisely two, layers made of the polymer having acid groups and/or having anhydride groups, and/or having groups derived therefrom, at least one layer, preferably precisely one layer, made of a polyolefin, where this layer has preferably been arranged between the layers made of the polymer having acid groups and/or having anhydride groups, and/or having groups derived therefrom. If appropriate, furthermore, the composite foil encompasses at least one further layer made of the further polymer described above, in particular between the at least one layer made of the polyolefin and the at least two layers made of the polymer having acid groups and/or having anhydride groups, and/or having groups derived therefrom.

The polymer having acid groups and/or having anhydride groups, and/or having groups derived therefrom, the polyolefin preferably arranged therebetween, the further polymer, and various of the composite foils have been described in detail above. To avoid repetition, reference is made to the corresponding passages of the description.

The thickness of a composite foil may be from 50 μm to 250 μm, preferably from 80 μm to 120 μm.

The thickness of the at least two layers made of the polymer having acid groups and/or having anhydride groups is preferably from 5 μm to 90 μm (in each case), the thickness of the layer made of the at least one polyolefin being from 5 μm to 100 μm, and the thickness of the at least one further layer made of the further polymer being from 1 μm to 20 μm.

The composite foil can, by way of example, be produced by calendering or by co-extrusion.

The abovementioned use relates to the use of a multilayer composite foil with at least one layer made of the polymer having acid groups and/or having anhydride groups, and/or having groups derived therefrom, and in particular of a composite foil for sealing the housing of a galvanic element, in particular of a galvanic element.

As mentioned above, the galvanic elements have particular suitability as energy-storage systems for chip cards, in particular, for electronic chip cards. The foil housing of a galvanic element is correspondingly designed to be very thin, its thickness generally being from 15 μm to 60 μm, in particular, from 30 μm to 40 μm.

A feature of an electronic chip card is that it has a galvanic element. Suitable chip cards within which a galvanic element can be installed are known, by way of example, from DE 103 04 824, the content of which is incorporated herein by reference.

Further features are apparent from the examples below. Individual features here can in each case be realized alone or in combination with one another. The different forms described serve merely for explanation and to improve understanding, and are in no way restrictive.

### Example

A three-layer composite foil was produced by superposing two EAA foils (mono-layer) of thickness 30 μm and a PP foil of thickness 50 μm in the sequence EAA-PP-EAA, and hot-calendering at 100° C. The resulting total thickness of the resultant composite foil was about 110 μm.

Another composite foil having five layers was produced via coextrusion from EAA, LDPE, and PP, using the sequence EAA-LDPE-PP-LDPE-EAA. The LDPE used can by way of example comprise the product “Affinity™” from Dow Chemicals. The product was found to have very good suitability as an adhesion promoter between the nonpolar polypropylene (PP) and the EAA containing acid groups and containing anhydride groups. The thicknesses of the individual layers in the composite foil are as follows:
EAA: 25 μm (in each case)
PP: 50 μm
LDPE: 10 μm (in each case).

A galvanic element was produced by saturating a positive electrode based on manganese oxide (MnO₂) with a liquid lithium electrolyte under inert gas and inserting it into a housing part made of copper foil. The negative electrode used comprised a lithium foil, which had been pressed into a second housing part made of copper foil roughened by the presence of copper crystallites.

The housing part with the positive electrode was then joined to the housing part with the negative electrode, and a composite foil having five layers and produced as described was arranged here between the housing parts. The flat cell was then sealed by pressing the two housing parts, and the composite foil arranged therebetween, onto one another with simultaneous heating to about 105° C.-115° C.

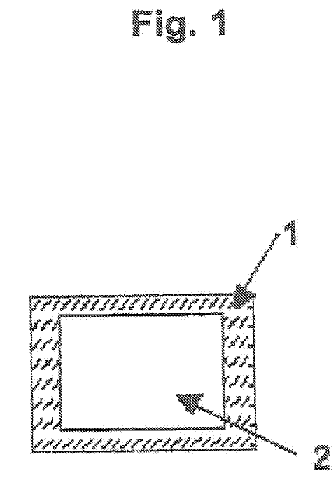

FIG. 1 illustrates a housing half (made of metal foil) of a galvanic element. A positive or a negative electrode is applied in region 2. The composite foil is arranged in the form of peripheral strip in region 1. Another housing half (made of metal foil) with the opposite-pole electrode can then be superposed from above. Sealing can then be achieved via pressure and heat in the marginal region 1. If a three-layer composite foil is used in the marginal region, the resultant sequence, viewed in cross section, is then housing foil -EAA-PP-EAA- housing foil.

It is also possible in principle to arrange two or more composite foils between the housing foils. If a three-layer composite foil was used in the marginal region the resultant sequence would then be housing foil -EAA-PP-EAA-EAA-PP-EAA- housing foil.

Galvanic elements produced in this way pass the ISO bending test to DIN ISO 7816-1 and also comply with the DIN ISO/IEC 10 373 test specification. They moreover exhibit very good properties in respect of impermeability (water-vapor barrier). In comparison with conventional products they exhibit a marked improvement in terms of discharge capacity after prolonged storage at room temperature and in terms of the rise in the internal resistance of the cell.

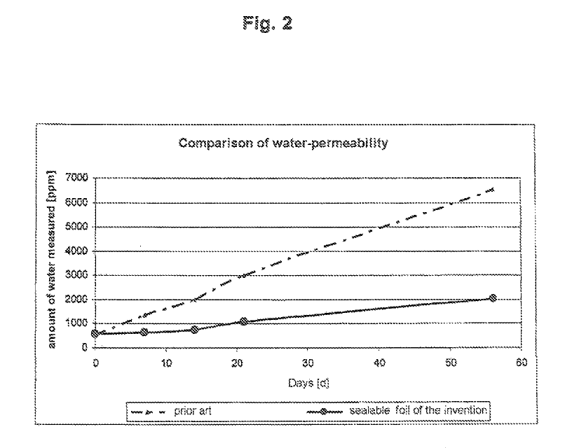

FIG. 2 illustrates the greatly improved water-barrier properties of the three-layer composite foil. Manganese dioxide cathodes dried in vacuo, these being very hygroscopic, were packed in copper housings with a sealable foil known from the prior art made of EVA as reference and, on the other hand, with the composite foil, and stored. The results in FIG. 2 show that the water values are significantly lower with our composite foil (continuous line in FIG. 2) than with the reference foil (broken line in FIG. 2). The results achievable with the five-layer composite foil are in essence identical.

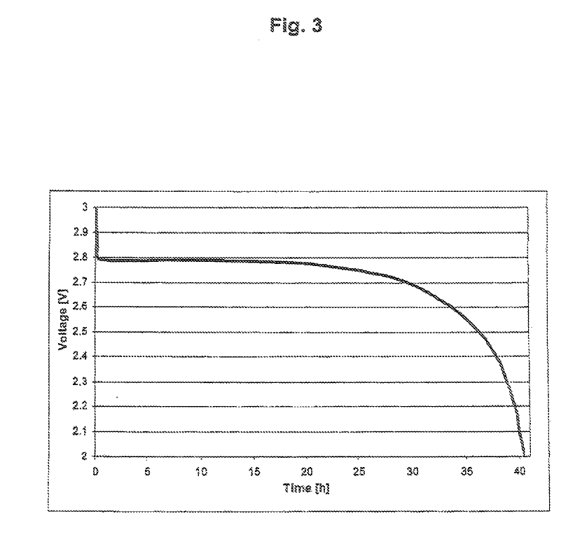

FIG. 3 shows the discharge curve for a flat primary cell using the three-layer sealing foil. The time-voltage curve shows that discharge is not adversely affected by ingress of moisture.

1. A galvanic element with a metallic foil housing which encloses at least one positive and at least one negative electrode, wherein the foil housing sealed by plastics foil comprising at least partly of a polymer which has acid groups and/or which has anhydride groups, and/or which has groups derived therefrom.

2. The galvanic element as claimed in claim 1, wherein the foil housing comprises two halves, one of which is in direct contact with the at least one positive electrode and the other is in direct contact with the at least one negative electrode.

3. The galvanic element as claimed in claim 1, wherein the plastics foil is a multilayer composite foil and at least one layer of the composite foil is composed of the polymer having acid groups and/or having anhydride groups, and/or having groups derived therefrom.

4. The galvanic element as claimed in claim 3, wherein the polymer having acid groups, and/or having anhydride groups, and/or having groups derived therefrom is an acrylic-acid- and/or methacrylic-acid-based polymer.

5. The galvanic element as claimed in claim 3, wherein the composite foil has at least one layer made of a unmodified polyolefin.

6. The galvanic element as claimed in claim 5, wherein the polyolefin is polypropylene (PP).

7. The galvanic element as claimed in claim 3, wherein the composite foil comprises at least two layers made of the polymer having acid groups and/or having anhydride groups, and/or having groups derived therefrom, and at least one layer made of the polyolefin, where the latter is arranged between the at least two layers made of the polymer having acid groups and/or having anhydride groups, and/or having groups derived therefrom.

8. The galvanic element as claimed in claim 7, further comprising at least one further layer made of a further polymer between the at least one layer made of the polyolefin and the at least two layers made of the polymer having acid groups and/or having anhydride groups, and/or having groups derived therefrom.

9. The galvanic element as claimed in claim 8, wherein the further polymer is a polyolefin.

10. The galvanic element as claimed in claim 1, having as the at least one positive electrode, at least one lithium intercalation electrode.

11. The galvanic element as claimed in claim 1, having as the at least one negative electrode, metallic lithium.

12. The galvanic element as claimed in claim 1, wherein the foil housing is composed of copper and/or of a copper alloy.

13. The galvanic element as claimed in claim 1, wherein cell height is from 200 μm to 500 μm.

14. A multilayered composite foil comprising at least two layers made of a polymer having acid groups and/or having anhydride groups, and/or having groups derived therefrom, at least one layer made of a polyolefin arranged between the at least two layers made of the polymer having acid groups and/or having anhydride groups, and/or having groups derived therefrom, and at least one further layer made of a further polymer arranged between the at least one layer made of the polyolefin and the at least two layers made of the polymer having acid groups and/or having anhydride groups, and/or having groups derived therefrom.

15. The composite foil as claimed in claim 1, having a thickness from 30 μm to 200 μm.

16. (canceled)

17. A chip card comprising a galvanic element as claimed in claim 1.

18. The galvanic element as claimed in claim 9, wherein the polyolefin is LDPE (low-density PE).
